(19) United States
(12) Patent Application Publication
(10) Pub. No.: US 2004/0032728 A1
(43) Pub. Date: Feb. 19, 2004

(54) Optical assembly for LED chip package

(76) Inventor: Robert Galli, Las Vegas, NV (US)

Correspondence Address: BARLOW, JOSEPHS & HOLMES, LTD., 101 DYER STREET, 5TH FLOOR, PROVIDENCE, RI, 02903, US

(21) Appl. No.: 10/636,465

(22) Filed: Aug. 7, 2003

Related U.S. Application Data
(60) Provisional application No. 60/404,489, filed on Aug. 19, 2002.

(51) Int. Cl. F21V 9/00

(52) U.S. Cl. 362/84; 362/293; 362/343

(57) ABSTRACT

An assembly is disclosed that provides for the installation of an inverted reflector cup over the optical dome of a light emitting diode (LED) package wherein the reflector has a single controlled output opening through which the output of the LED is focused. The reflector assembly is designed to completely cover the light output end of the LED package in order to capture all of the light being emitted from the LED chip. The interior surface of the reflector is curved to redirect as much of the emitted light toward the front of the optical package as possible. The present invention is particularly suited for use a variety of lighting devices including but not limited to flashlights, specialty architectural grade lighting fixtures and vehicle lighting.

### CROSS-REFERENCE TO RELATED APPLICATIONS

This application is related to and claims priority from earlier filed provisional patent application No. 60/404,489, filed Aug. 19, 2002.

### BACKGROUND OF THE INVENTION

The present invention relates to a new reflector assembly for use with a light emitting diode (LED) device. More specifically, the present invention relates to an inverted reflector for installation over an LED lamp that collects and concentrates the light emitted from the LED to provide a narrowed and collimated beam output.

Currently, manufacturers are producing a wide range of high brightness LED packages in a variety of forms. These packages range from conventional LED lamps to LED's that use emitter chips of much greater size and much higher power consumption. In general, however, the protective dome placed over the emitter chip, while intending to provide a level of optical concentration of the light, generally produces a relatively wide-angle beam. One example of a high brightness LED of this type is the Level 1 Assembly LED, manufactured by Luxeon. The Luxeon LED uses an emitter chip that is four times greater in size than the emitter chip used in standard LED lamps. While this LED produces a much greater light output than the standard LED, it produces a very disperse wide-angle beam that is difficult to capture for efficient collimation and beam imaging in practical application, such as in a flashlight. As a result, a great deal of the output energy is lost as leakage out the side of the LED package.

Generally, when these high intensity LED's are incorporated into a flashlight, the manufacturer attempts to image and transfer as much light as possible from the LED to the flashlight beam by using large diameter, long focal length lenses. While this solution provides an adequate output beam in the flashlight, two distinct issues arise. First, the imaged beam is inefficient because as noted above, much of the light in these LED packages escapes from the side of the LED thus being lost within the flashlight and not transferred into the far field beam image captured by the lens. Second, since these lenses are imaging an LED die that is coated With a yellow phosphor layer, the beam inherits a yellowish cast. Therefore, there is a need for an assembly that can successfully concentrate and transfer as much of the available light emitted from an LED into the far field of the flashlight beam.

In order to capture the light leaking at the sides of the LED package and improve the efficiency of the overall assembly, many manufacturers have placed the LED packages into openings at the rear of traditional parabolic type reflectors as are well known in the art. While these reflectors capture and redirect a great deal of the light output, they provide a low quality image in the far field of the lighting device. These reflectors simply transfer a large image of the LED die into the far field of the beam resulting in poor quality illumination.

There is therefore a need for a unique reflector design that is tailored for use with high output LED packages that has improved efficiency in capturing and transferring a high percentage of the lamp output, while providing a high quality light image in the far field of the light beam.

### BRIEF SUMMARY OF THE INVENTION

In this regard, the present invention provides for a novel lighting assembly that utilizes a high intensity LED with a unique inverted reflector arrangement to capture and redirect the light output into a collimated and homogenized beam. The assembly is particularly suited for use in compact lighting assemblies such as flashlights.

In accordance with the present invention, an assembly is disclosed that provides for the installation of an inverted reflector cup over the optical dome of the LED package. The reflector cup has a single controlled output opening through which the output of the LED is focused. The reflector assembly is designed to completely cover the light output end of the LED package in order to capture all of the light being emitted from the LED chip. The interior surface of the reflector is curved in such a manner to redirect as much of the emitted light toward the front of the optical package as possible. This re-direction happens in two ways. First, some of the light escapes the output opening from LED directly or on a single direct bounce from a surface of the reflector. Second, light that does not escape is redirected towards the emitter chip. A portion of this light is then reflected off the surface of the emitter and out of the output opening. The remaining light, that is not reflected as described above, re-excites the emitter chip and phosphor to enhance the light output of the LED.

As stated above, while the present invention is particularly suited for use in flashlights, the disclosed assembly can be incorporated into a variety of lighting devices including but not limited to flashlights, specialty architectural grade lighting fixtures and vehicle lighting.

Accordingly, one of the objects of the present invention is the provision of a lighting assembly that includes a high intensity LED and a reflector disposed thereon that homogenizes and collimates the light output from the LED. Another object of the present invention is the provision of a compact lighting assembly that includes a high intensity LED and a reflector that work in conjunction to approximate a point source of illumination. A further object of the present invention is the provision of a compact high intensity LED and reflector lighting assembly that is particularly suited for use in portable lighting devices such as flashlights. Yet another object of the present invention is to provide a compact lighting source that creates a high quality, high intensity output that can be further imaged and focused using optics to provide a focused level of output in the far field of the lighting device.

Other objects, features and advantages of the invention shall become apparent as the description thereof proceeds when considered in connection with the accompanying illustrative drawings.

### BRIEF DESCRIPTION OF THE DRAWINGS

In the drawings which illustrate the best mode presently contemplated for carrying out the present invention:

FIG. 1 is a side view of a high intensity LED package of the prior art;

FIG. 2 is a side view of a high intensity LED package of the prior art in conjunction with a conventional lens;

FIG. 3 is a side view of a high intensity LED package of the prior art in conjunction with a conventional reflector;

FIG. 4 is an exploded perspective view of a high intensity LED package and the reflector of the present invention;

FIG. 5 is a perspective view of the interior of the reflector of the present invention;

FIG. 6 is a cross-sectional view of the high intensity LED and reflector assembly taken along line 6-6 of FIG. 4;

FIG. 7 is a cross sectional view thereof shown in combination with a lens; and

FIG. 8 is a cross sectional view of a high intensity LED shown with an alternate embodiment of the reflector of the present invention.

### DETAILED DESCRIPTION OF THE INVENTION

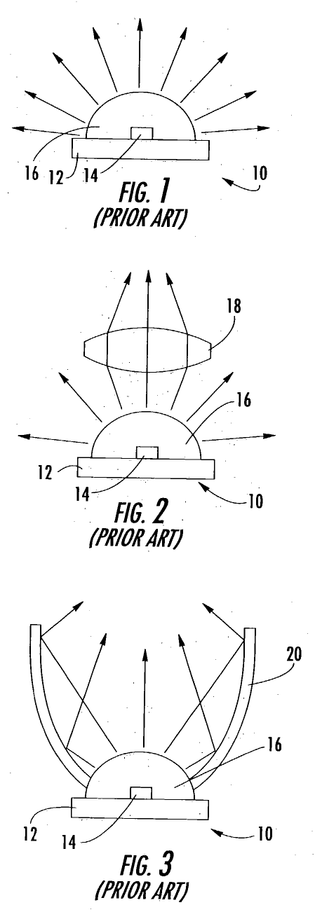

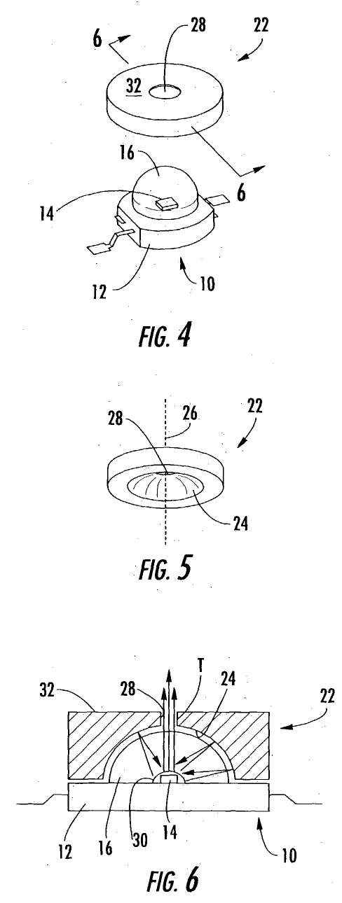

Referring now to the drawings, FIGS. 1, 2 and 3 illustrate a high intensity LED 10 as described in the present invention, wherein the LED 10 includes a base 12, an emitter die 14 and an optical housing 16. While the LED 10 shown includes conventional construction details, the LED 10 could be manufactured as only an emitter die 14 with the optical housing 16 and base 12 eliminated. In such a configuration, the emitter die 14 may be simply mounted onto a circuit board (not shown). In this regard, the particular construction of the LED 10 is not intended to be limiting on the scope of the present invention except as defined by the claims herein. FIGS. 2 and 3 further illustrate prior art attempts to capture and redirect the output from the LED 10 assembly. FIG. 2 shows a traditional optical lens 18. As can be clearly seen, much of the light is lost as it bleeds to the sides of the LED 10 and is not captured by the lens 18. FIG. 3 shows a parabolic reflector 20 installed around the LED 10. While this configuration captures the light emitted from the side of the LED 10, it simply re-images the emitter die 14 of the LED 10 in the far field image, producing undesirable illumination of the target.

Tuning now to FIGS. 4 and 5, the inverted reflector of the present invention is illustrated and generally indicated as 22. The reflector 22 is shown as being disk shaped, and is show in combination with a traditionally constructed LED 10 as described above. The reflector 22 has an inner reflective surface 24 that forms an inverted reflector cup. The reflective surface 24 has an optical axis 26 that generally passes directly through the center of the reflector 22. Further, the reflective surface 24 has an apex of curvature that is located along the optical axis 26. An aperture 28 is provided through the reflector disk 22, is generally located at the apex of the reflective surface 24, and is centered on the optical axis 26. As can be best seen in FIG. 4, the reflector 22 is configured to be placed over the output end of the LED 10 and entirely enclose the emitter chip 14 and optical housing 16. While the reflector 22 is shown as being disc shaped, it can be appreciated that other configurations and shapes would fall within the present disclosure. For example, the reflector 22 may be square or polygonal. Further, the reflective surface 24 may be parabolic, spherical or ellipsoidal. The reflective surface 24 may also be smooth or faceted as is well known in the art. In this manner, the present invention provides for the shape of the reflector 22 and the reflective surface 24 to be tailored to suit the particular LED 10 package with which it will be used.

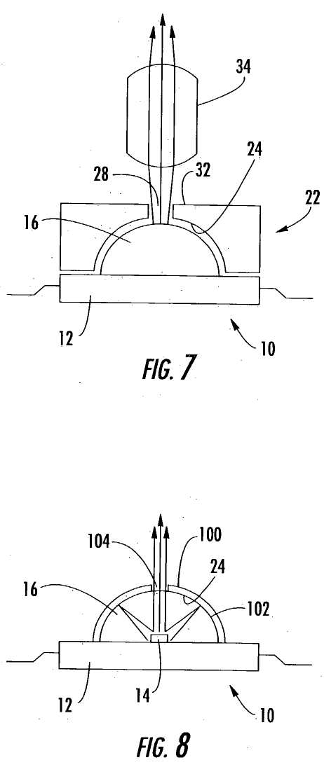

Turning now to FIG. 6, the reflector 22 of the present invention is shown in its operative position in conjunction with an LED 10 package. The reflector 22 is placed into overlying relation with the LED 10 so that the entire optical housing 16, and emitter chip 14 are enclosed entirely within the reflective surface 24. It can be appreciated that while the LED 10 in this figure is shown to include an optical housing 16, the optical housing 16 could easily be eliminated without detracting from the scope or performance of the present invention. In this assembled relation, it can be seen that the optical axis 26 of the reflective surface 24 is in substantial alignment with an axis that passes through the center of the LED 10 emitter chip 14. Further, the aperture 28 at the center of the reflective surface 24 is also aligned on the central axis of the emitter die 14. The aperture 28 provides an opening through which a predetermined portion of light that emanates from the emitter die 14 is allowed to escape in a concentrated beam having a narrow angle. The portion of light that is not exiting the LED 10 package within the angle required by the aperture 28 in the reflective surface 24 is re-directed back onto the emitter chip 14. This re-direction happens in two ways. A portion of the re-directed light is reflected directly off the surface of the emitter 14 and out of the aperture 28. The remaining light, that is not reflected as described above, re-excites the emitter chip 14 to enhance the light output of the LED 10.

The reflector 22 of the present invention can be adjusted to be used in conjunction with all of the conventional LED 10 colors that are available. Some LED's 10 are manufactured to include only an emitter die 14 that outputs light in the desired wavelength directly. For example, red, blue and green LED's 10 all have output wavelengths that are the direct result of simply energizing the emitter die 14. White LED's 10 are produced by adding a phosphor coating 30 over the emitter die 14. When the emitter die 14 is energized, it has an output at one wavelength. Some of the output energizes the phosphor 30 to create additional output at a second wavelength and some of the output bleeds through the phosphor 30 directly. The wavelength of the emitter die 14 and the wavelength of the phosphor 30 are selected so that they are complementary and when combined produce a white light output. For example, a popular, well-known white LED 10 that is available on the market today utilizes a blue emitter chip 14 and a yellow phosphor 30. In this manner, a coating may be provided on the reflective surface 24 to reflect selective wavelengths of light. When used in conjunction with a White LED 10 having a yellow phosphor 30 coating, the reflective surface 24 may be plated with nickel material or have a slightly blue coating. The light that is directed back onto the yellow phosphor 30 therefore has a bluish cast that counteracts the fact that the reflected light would normally become yellow and results in a white light output. Similarly, when an emitter die 14 is used that does not have a phosphor coating 30, the color of the coating on the interior of the reflective surface 24 may be closely matched to the output wavelength of the die 14 to further enhance the color of the overall assembly output. For example should an UV emitter chip 14 be used with a white phosphor 30 the spectral shift would not be a factor and a nickel reflector 22 could be used. Similarly, should an LED 10 that does not have a phosphor coating 30 be employed, a reflector color that is matched to the output frequency of the emitter chip 14 can be used.

The reflector 22 assembly may or may not have a defined thickness T around the perimeter of the aperture 28. This will be determined by the optical requirements of the system into which the assembly is installed. Should a very low diffusion be desired, a very sharp edge having a thickness T that approaches zero will be provided. Should higher edge diffusion be required, a thicker edge T will be used. Further to improve imaging of the light output from the assembly, the present invention may include a flat black coating on the top, outside surface 32 of the reflector 22. By providing this coating 32, a high level of contrast is provided between the beam image that exits the aperture 28 and the background surface 32 of the reflector 22 that produces a high quality image for capture and transfer into the light beam far field.

Additionally, the present invention can be used as a stand-alone assembly or in conjunction with other optical elements. As can be seen in FIG. 7 for example, a lens 34 can also be used to capture the near field image of the assembly output beam and image it into the far field of the light beam. In this fashion a particularly desirable optical element is an optical drum lens 34 that in addition to having a relatively short focal length, thus allowing the lens to be placed very close to the assembly, the lens 34 assists in further collimating and homogenizing the beam. This type of assembly can therefore produce a highly homogenized light beam with a tight circular appearance while operating with a high level of efficiency.

An alternate embodiment of the present invention is shown in FIG. 8. In this embodiment, rather than placing a separately machined reflector cup 22 over the LED package 10, the reflective surface 24 can be created as a reflective layer 100 that is plated onto the outer surface 102 of the LED package 10 at the time of manufacture. The reflective plating 100 would have an opening 104 near the top apex of the LED package 10 through which the light will be allowed to escape. In all other respects, the LED package 10 would operate in accordance with the other features of the invention as described herein. In addition, the plating 100 can be color matched with the wavelength of the emitter chip 14 output to produce the desired overall package output. At the lowest level, the coating 100 could simply consist of a layer of white Teflon provided over the optical housing 16 as a rudimentary reflector assembly. Testing has shown that simply providing a Teflon covering with an opening of approximately 25% of the LED die size provided a luminance boost in the effective LED output of between 10-20%. Further, the coating 100 disclosed herein returns approximately 75% of the light back onto the LED 10 emitter die 14 that produces a boost of nearly 50% for on axis (useable and collimated) illumination. These tests show that the assembly of the present invention provides a LED/reflector assembly that provides a much more efficient and usable illumination assembly for incorporation into lighting devices.

It can therefore be seen that the present invention provides a compact assembly that captures and redirects a substantial portion of the diffuse light output from a high intensity LED package 10. The reflector 22 assembly of the present invention greatly enhances the output efficiency of the overall device while creating a compact assembly that can be easily incorporated into a lighting assembly such as a flashlight. Further, the present invention can be modified to accommodate a number of standard LED manufacturing configurations and colors to create an output beam with previously unknown efficiency. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A lighting assembly comprising:
a light emitting diode having an optical axis; and
an inverted reflector assembled in overlying relation with said light emitting diode, said reflector including a body having a reflective surface, said reflective surface having an optical axis, said body further having an aperture aligned with said optical axis of said reflective surface;
wherein said optical axis of said reflective surface is aligned with said optical axis of said light emitting diode, said reflector being aligned and configured to direct light output from said light emitting diode back onto said light emitting diode, said aperture allowing light output that is substantially aligned with said optical axis of said reflective surface to exit said assembly.

2. The lighting assembly of claim 1, said light emitting diode including an optical housing, said housing having an outer surface, said reflective surface being configured to substantially match the shape of said outer surface of said housing.

3. The lighting assembly of claim 2, wherein said outer surface of said housing and said reflective surface are parabolic.

4. The lighting assembly of claim 2, wherein said outer surface of said housing and said reflective surface are ellipsoidal.

5. The lighting assembly of claim 2, wherein said outer surface of said housing and said reflective surface are spherical.

6. The lighting assembly of claim 1, said light emitting diode further comprising:
an emitter die, said emitter having a light output at a first wavelength; and
a phosphor coating on said emitter die, said phosphor energized by said light output at said first wavelength, said phosphor having a light output at a second wavelength complementary to said first wavelength, said first and second wavelengths cooperating to form substantially white light output in the visible range.

7. The lighting assembly of claim 6, wherein said phosphor coating is a mixture of red, green and blue phosphors.

8. The lighting assembly of claim 6, wherein said first wavelength substantially corresponds to blue in the visible light spectrum and said second wavelength substantially corresponds to yellow in the visible light spectrum.

9. The lighting assembly of claim 6, wherein said reflective surface includes a coating thereon, wherein the color of said coating is selected to reflect light at a third wavelength that is complementary to the color of said phosphor, said first, second and third wavelengths cooperating to form substantially white light output in the visible range.

10. The lighting assembly of claim 8, wherein said reflective surface includes a coating thereon, wherein the color of said coating is selected to reflect light at a third wavelength that is complementary to the color of said phosphor, said first, second and third wavelengths cooperating to form substantially white light output in the visible range.

11. The lighting assembly of claim 1, said light emitting diode further comprising:
an emitter die, said emitter having a light output at a first wavelength; and
a coating on said reflective surface, wherein the color of said coating is selected to reflect light at a second wavelength that is substantially matched to said first wavelength, said first and second wavelengths cooperating to form light output in a narrowly selected wavelength range in the visible spectrum.

12. A lighting assembly comprising:
a light emitting diode having an emitter chip and an optical housing, said optical housing having an optical axis and an outer surface, said emitter chip having a first portion of light output substantially aligned with said optical axis of said housing and a second portion of light output that is not substantially aligned with said optical axis of said housing; and
an inverted reflector assembled in overlying relation with said light emitting diode, said reflector including a body having a reflective surface, said reflective surface having an optical axis, an apex and a focal point, said reflective surface being configured to substantially match the shape of said outer surface of said housing, said body further having an aperture aligned with said optical axis of said reflective surface at said apex of said reflective surface;
wherein said optical axis of said reflective surface is aligned with said optical axis of said optical housing, said focal point of said reflective surface being aligned and configured to direct said second portion of the light output from said emitter chip back onto said emitter chip, said aperture allowing said first portion of the light output from said emitter chip to exit said assembly.

13. The lighting assembly of claim 12, wherein said outer surface of said housing and said reflective surface are parabolic.

14. The lighting assembly of claim 12, wherein said outer surface of said housing and said reflective surface are ellipsoidal.

15. The lighting assembly of claim 12, wherein said outer surface of said housing and said reflective surface are spherical.

16. The lighting assembly of claim 12, wherein said emitter die has a light output at a first wavelength, and further includes a phosphor coating on said emitter die, said phosphor energized by said light output at said first wavelength, said phosphor having a light output at a second wavelength complementary to said first wavelength, said first and second wavelengths cooperating to form substantially white light output in the visible range.

17. The lighting assembly of claim 16, wherein said reflective surface includes a coating thereon, wherein the color of said coating is selected to reflect light at a third wavelength that is complementary to the color of said phosphor, said first, second and third wavelengths cooperating to form substantially white light output in the visible range.

18. The lighting assembly of claim 12, wherein said emitter die has a light output at a first wavelength, and said reflective surface includes a coating thereon, wherein the color of said coating is selected to reflect light at a second wavelength that is substantially matched to said first wavelength, said first and second wavelengths cooperating to form light output in a narrowly selected wavelength range in the visible spectrum.

19. A light emitting diode comprising:
a body;
an emitter die mounted onto said body;
an optical housing disposed over said emitter die, said optical housing having an optical axis and an outer surface; and
a reflective coating covering substantially all of said outer surface of said optical housing, said reflective coating having an aperture therein, said aperture being substantially aligned with said optical axis of said housing.

20. The light emitting diode of claim 19, wherein said reflective coating is configured to direct light output from said light emitting diode back onto said emitter die, said aperture allowing light output that is substantially aligned with said optical axis of said optical housing to exit said light emitting diode.

21. The light emitting diode of claim 20, wherein said outer surface of said housing and said reflective coating are parabolic.

22. The light emitting diode of claim 20, wherein said outer surface of said housing and said reflective coating are ellipsoidal.

23. The light emitting diode of claim 20, wherein said outer surface of said housing and said reflective coating are spherical.

24. The light emitting diode of claim 19, said emitter die having a light output at a first wavelength, said emitter further including a phosphor coating thereon, said phosphor energized by said light output at said first wavelength, said phosphor having a light output at a second wavelength complementary to said first wavelength, said first and second wavelengths cooperating to form substantially white light output in the visible range.

25. The light emitting diode of claim 24, wherein said first wavelength substantially corresponds to blue in the visible light spectrum and said second wavelength substantially corresponds to yellow in the visible light spectrum.

26. The light emitting diode of claim 24, wherein said phosphor coating is a mixture of red, green and blue phosphors.

27. The light emitting diode of claim 24, wherein said reflective surface includes a coating thereon, wherein the color of said coating is selected to reflect light at a third wavelength that is complementary to the color of said phosphor, said first, second and third wavelengths cooperating to form substantially white light output in the visible range.

28. The light emitting diode of claim 20, said emitter having a light output at a first wavelength and said reflective coating having a color, wherein the color of said coating is selected to reflect light at a second wavelength that is substantially matched to said first wavelength, said first and second wavelengths cooperating to form light output in a narrowly selected wavelength range in the visible spectrum.
